(19) United States
(12) Patent Application Publication
(10) Pub. No.: US 2016/0190827 A1
(43) Pub. Date: Jun. 30, 2016

(54) CHARGING DEVICE AND METHOD FOR THE SAME, AND DISCHARGING DEVICE AND METHOD FOR THE SAME

(71) Applicant: KABUSHIKI KAISHA TOSHIBA, Minato-ku (JP)

(72) Inventors: Toru EZAWA, Kawasaki (JP); Takashi KAMITAKE, Meguro (JP)

(73) Assignee: KABUSHIKI KAISHA TOSHIBA, Minato-ku (JP)

(21) Appl. No.: 15/065,095

(22) Filed: Mar. 9, 2016

Related U.S. Application Data
(63) Continuation of application No. PCT/JP2014/073709, filed on Sep. 8, 2014.

(30) Foreign Application Priority Data
Sep. 19, 2013 (JP) 2013-194595

(51) Int. Cl. H02J 7/00

(52) U.S. Cl. CPC H02J 7/007; H02J 7/0063; H02J 7/0052; H02J 2007/0067

(57) ABSTRACT

According to one embodiment, a charging device includes: a battery controller, an executor, a voltage measurer, a voltage corrector and a diagnoser. The battery controller controls charging of a storage battery. The executor charges the storage battery using the battery controller and changes a charge rate of the storage battery in a case that a predetermined condition is established during a time period when the storage battery is charged. The voltage measurer measures a voltage of the storage battery during a time period when the storage battery is charged by the battery controller. The voltage corrector corrects the voltage measured by the voltage measurer on a basis of a value of a current rate at which the voltage is measured. The diagnoser diagnoses the storage battery on a basis of the voltage corrected by the voltage corrector.

### CROSS REFERENCE TO RELATED APPLICATIONS

This application is a Continuation of International Application No. PCT/JP2014/073709, filed on Sep. 8, 2014, the entire contents of which is hereby incorporated by reference.

### FIELD

Embodiments of the present invention relate to a charging device and a method therefor, and a discharging device and a method therefor.

### BACKGROUND

Roles of a storage battery such as renewable energy of PV (photovoltaic power generation), stabilization of a power system and an EV (electric vehicle) are becoming extremely important. A storage battery system is a form of utilizing a storage battery (battery pack) for which a plurality of battery cells (cells, hereinafter) are connected in order to cope with many kinds of the utilization situations. It is desired to use the storage battery system safely and at ease, and it is important that the entire storage battery system is not easily degraded.

In recent years, as all electronic devices spread and a living environment is electronized, larger and larger capacity has been demanded for the storage battery system, and the number of connections of the cells configuring one storage battery system is becoming very big. At present, there is a result that the storage battery system including about several thousands of cells is adopted for the EV.

In the storage battery which is repeatedly charged and discharged many times, a capacity and resistance are known to be degraded with use. In order to diagnose a degree of degradation, an AC impedance method and a method of performing charging and discharging operations have been adopted. Among them, a method of diagnosing states of the capacity, the resistance and an active material further of the storage battery by utilizing a charging voltage curve and a charging voltage differential curve has been devised. For this diagnosis, a method of acquiring the charging voltage curve during charging and making a diagnosis utilizing the charging voltage curve is basically preferable as practical use. In charging of the storage battery at present, there are normal charging of performing charging taking a long time and rapid charging of performing charging at once in a short time, and it is clear that utilization is easy for a user when the rapid charging is performed preferably. However, when the rapid charging is performed, it is conceivable that sampling of the charging voltage curve which can be acquired becomes sparse, and there is a problem in accuracy when diagnosing the degradation degree utilizing the charging voltage curve. On the other hand, when sampling of the charging voltage curve is to be taken densely by the normal charging, charging takes time and it is not easy to use for a user.

### BRIEF DESCRIPTION OF THE DRAWINGS

FIG. 1 is a block diagram of a charging device with a diagnostic function relating to a first embodiment of the present invention;

FIG. 2 is a flowchart of an operation relating to the first embodiment of the present invention;

FIG. 3 is a diagram illustrating an example of a charging voltage curve database relating to the first embodiment of the present invention;

FIG. 4 is a diagram illustrating a section-specific charge rate database relating to the first embodiment of the present invention;

FIG. 5 is a diagram illustrating a charging voltage curve and an example 1 of a charging schedule when acquiring the charging voltage curve relating to the first embodiment of the present invention;

FIG. 6 is a diagram illustrating a charging voltage curve and an example 2 of a charging schedule when acquiring the charging voltage curve relating to the first embodiment of the present invention;

FIG. 7 is a block diagram of a charging device with a diagnostic function relating to a second embodiment of the present invention;

FIG. 8 is a diagram illustrating an example of a charging voltage curve database relating to the second embodiment of the present invention;

FIG. 9 is a block diagram of a discharging device with a diagnostic function relating to a third embodiment of the present invention;

FIG. 10 is a flowchart of an operation relating to the third embodiment of the present invention;

FIG. 11 is a diagram illustrating an example of a discharging voltage curve relating to the third embodiment of the present invention;

FIG. 12 is a block diagram of a charging device with a diagnostic function relating to a fourth embodiment of the present invention;

FIG. 13 is a flowchart of an operation relating to the fourth embodiment of the present invention;

FIG. 14 is a block diagram of a charging device with a diagnostic function relating to a fifth embodiment of the present invention;

FIG. 15 is a flowchart of an operation relating to the fifth embodiment of the present invention;

FIG. 16 is a block diagram of a charging device with a diagnostic function relating to a sixth embodiment of the present invention;

FIG. 17 is a flowchart of an operation relating to the sixth embodiment of the present invention;

FIG. 18 is a block diagram of a charging device with a diagnostic function relating to a seventh embodiment of the present invention;

FIG. 19 is a flowchart of an operation relating to the seventh embodiment of the present invention;

FIG. 20 is a block diagram of a charging device with a diagnostic function relating to an eighth embodiment of the present invention; and

FIG. 21 is a flowchart of an operation relating to the eighth embodiment of the present invention.

### DETAILED DESCRIPTION

According to one embodiment, a charging device includes: a battery controller, an executor, a voltage measurer, a voltage corrector and a diagnoser. The battery controller controls charging of a storage battery. The executor charges the storage battery using the battery controller and changes a charge rate of the storage battery in a case that a predetermined condition is established during a time period when the storage battery is charged. The voltage measurer measures a voltage of the storage battery during a time period when the storage battery is charged by the battery controller. The voltage corrector corrects the voltage measured by the voltage measurer on a basis of a value of a current rate at which the voltage is measured. The diagnoser diagnoses the storage battery on a basis of the voltage corrected by the voltage corrector.

Hereinafter, with reference to the drawings, embodiments of the present invention will be described.

### First Embodiment

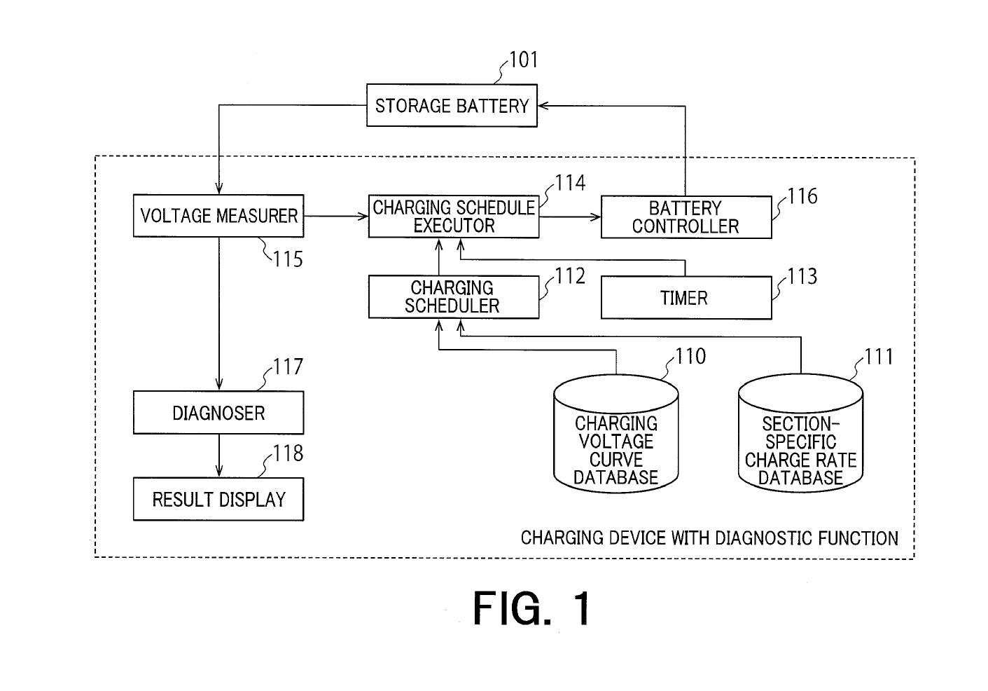

FIG. 1 is a block diagram of a charging device (charging computer) with a diagnostic function relating to a first embodiment of the present invention.

This charging device with the diagnostic function is characterized in that, in the case of sampling a voltage and acquiring a charging voltage curve while charging a storage battery from a voltage value equal to or lower than a predetermined voltage, and diagnosing the storage battery based on the acquired charging voltage curve, a charge rate is changed according to a section of a charging voltage during charging. Sampling is performed densely by normal charging in a section important for diagnosing a degradation degree, and sampling is performed sparsely by performing rapid charging in a section not important for diagnosing the degradation degree conversely. It is assumed that a sampling rate is constant during the charging. Thus, while shortening charging time, the degradation degree of the storage battery can be accurately diagnosed. Hereinafter, details of the charging device with the diagnostic function in FIG. 1 will be described.

A battery controller 116 controls charging and discharging of a storage battery 101 under control of a charging schedule executor 114.

A timer 113 has a function of counting the time.

A voltage measurer 115 measures a voltage of the storage battery 101 during a time period when a charging schedule is executed by the charging schedule executor 114. Also, before the charging schedule is executed, an instruction of the charging schedule executor 114 is received and the voltage of the storage battery 101 is measured. Here, the charging schedule in the present embodiment determines the charge rate according to the time from charging start.

A charging scheduler 112 makes the charging schedule on the basis of information of a charging voltage curve database (hardware storage) 110 and information of a section-specific charge rate database (hardware storage) 111.

The section-specific charge rate database 111 stores information that specifies the charge rate according to the section of a battery voltage for each type of a battery.

FIG. 4 illustrates an example of the section-specific charge rate database 111.

In FIG. 4, for the section of the battery voltage, whether the section is an important section or an unimportant section is indicated for each type of the battery. The type of the battery is specified by a company name and a product name as one example. “A” indicates the unimportant section, “B” indicates the important section, and “C” indicates the section more important than “B”. The sections are defined in two stages of “A” and “B” in types 1 and 2, and the sections are defined in three stages of “A”, “B” and “C” in a type 3. The individual sections “A”, “B” and “C” are made to correspond to respectively different charge rates. The charge rate is higher in the order of “A”, “B” and “C”. That is, the charge rate is the highest for “A”. Values of the individual charge rates for “A”, “B” and “C” may be different according to the types of the battery. Thus, since the charge rate is lower for the more important section, sampling can be performed in a high density. Information in which the section (voltage) and the charge rate are made to correspond is called charge rate information.

In this way, the section-specific charge rate database 111 stores the information that specifies the charge rate according to the section of the battery voltage in a form of corresponding to the importance for each type of the battery. Correspondence of the individual sections and the importance (“A”, “B”, “C” or the like) can be arbitrarily given by a user, or may be automatically given by learning described later. Also, by the learning described later, a type may be newly added. The voltages and the number of the types indicated in FIG. 4 are just examples and are not limited thereto. Note that, without determining the charge rate for each section that is discretely divided, the charge rate may be determined continuously for each point (for each sampling).

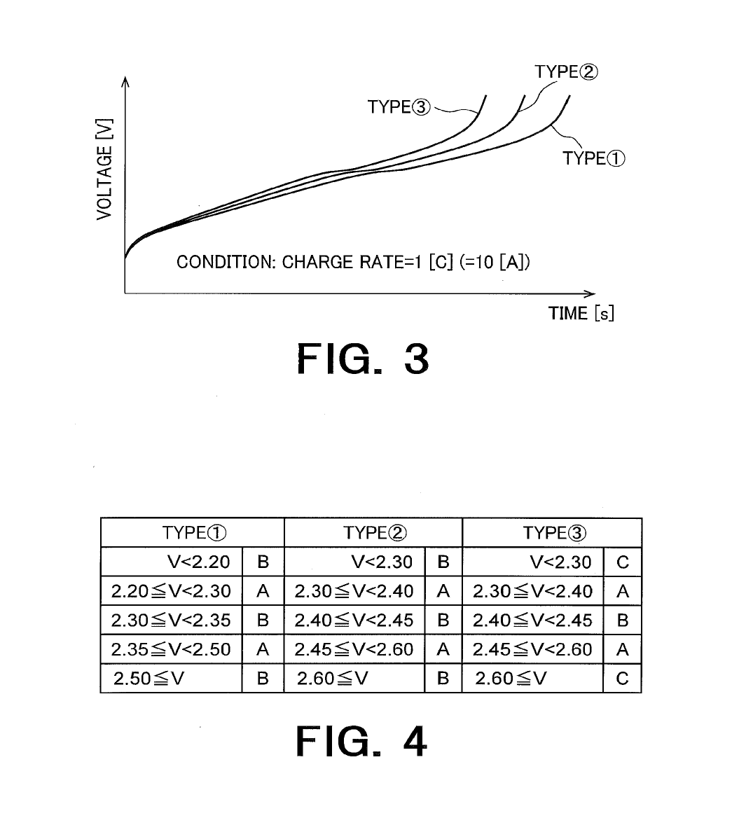

The charging voltage curve database 110 stores the charging voltage curve in the case that charging is performed at a certain specified charge rate. FIG. 3 illustrates an example of the charging voltage curve database 110. The charging voltage curves of three types of the batteries are stored similarly to FIG. 4. A horizontal axis is time [s], and a vertical axis is a voltage [V]. In the illustrated example, the charge rate is 1 [C], and is specifically 10 [A]. However, the value of the charge rate and the number of the types are just examples and are not limited thereto.

As described above, the charging scheduler 112 makes the charging schedule on the basis of the information of the charging voltage curve database 110 and the information of the section-specific charge rate database 111. The charging schedule made here determines the charge rate to be used according to the time from the charging start.

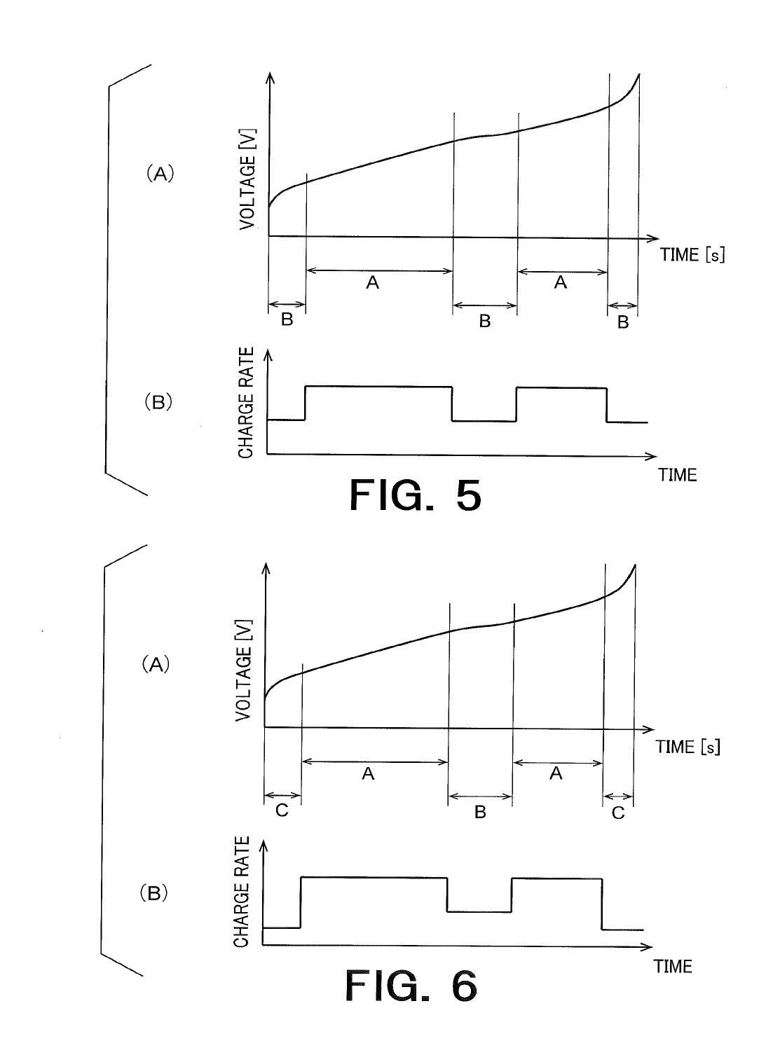

The charging scheduler 112 checks a charging state of the connected storage battery 101, defines the charging state as a start point when it is equal to or lower than a predetermined voltage, and when it is higher than the predetermined voltage, performs discharging processing until it becomes equal to or lower than the predetermined voltage, and defines the charging state after the discharging processing is performed as the start point. For example, for the type 1 in FIG. 4, the predetermined voltage is defined as 2.2 [V] for example. Here, description is continued assuming the case of the type 1. From information on a change of the voltage according to the charge rate and the time as illustrated in FIG. 3, the time before getting out of the section to which the start point belongs first is calculated. For example, when the start point is 2.0 [V], the time before reaching an end voltage 2.2 [V] of the first important section “B” (reaching the first unimportant section “A”) is calculated. Next, with a start voltage of the unimportant section “A” that is reached first as a start point, from the information on the change of the voltage according to the charge rate and the time as illustrated in FIG. 3, the time before getting out of the section “A” (the time before reaching 2.3 [V] which is an end voltage of the section “A”) is calculated. By repeating such calculation, the charging schedule of time control on for how long charging is to be performed at the charge rate corresponding to the respective sections that are the unimportant section and the important section is made. An end of the charging may be completion of the charging (until no more current flows), or an arbitrarily voltage equal to or higher than 2.5 [V] may be specified by a user to make a schedule. Note that, in the case that the start point coincides with the predetermined voltage (2.2 [V]), the first important section “B” is not included in the schedule and the schedule is made from the first unimportant section. Note that, while an example of a current rate of 10 [A] is illustrated in FIG. 3, a relation between the time and the voltage at the respective charge rates for the sections “A” and “B” is assumed to be stored in the charging voltage curve database 110 in a similar form. Or, data at the charge rate of 10 [A] illustrated in FIG. 3 may be corrected to generate the relation between the time and the voltage at the respective charge rates for the sections “A” and “B”. One example of the charging schedule that is made is illustrated in FIG. 5(B). The horizontal axis is the time and the vertical axis is the charge rate. Here, an example of the charging schedule for the case that there are two kinds of the sections “A” and “B” is illustrated. The charge rate is high in the section “A”, and the charge rate is low in the section “B”.

Another example of the charging schedule is illustrated in FIG. 6(B). Here, an example of the charging schedule for the case that there are three kinds of the sections “A”, “B” and “C” is illustrated. The charge rate is high in the section “A”, the charge rate is lower in the section “B” than that in “A”, and the charge rate is further lower in the section “C” than that in “B”.

The charging schedule executor 114 charges the storage battery 101 while controlling the battery controller 116 on the basis of the charging schedule generated by the charging scheduler 112, and samples the voltage during the charging at a specified sampling rate using the voltage measurer 115. Since a diagnosis is made by starting the charging from the voltage equal to or lower than a predetermined voltage value, the charging schedule executor 114 checks whether or not the voltage of the storage battery 101 is equal to or lower than the predetermined voltage using the voltage measurer 115 before the start, and when it is higher than the predetermined voltage, uses the battery controller 116 to discharge the storage battery 101.

A diagnoser 117 acquires a voltage value measured by the voltage measurer 115 during a time period when the charging schedule is executed, and diagnoses the storage battery 101 on the basis of the data of the voltage and the time. Or, the information of the charge rate may be acquired from the battery controller 116, and a diagnosis may be made on the basis of three-dimensional data of the voltage, the time, and a current. The diagnoser 117 generates the charging voltage curve which is one example of the information indicating the relation between the voltage and the time for example, and makes a diagnosis on the basis of the charging voltage curve. Or, a curve indicating a relation between the voltage and a charge amount (this curve is also called the charging voltage curve in the present paragraph) may be generated and the diagnosis may be made based on the charging voltage curve. In the case of diagnosing the degradation degree of the storage battery 101 on the basis of the charging voltage curve, the diagnoser 117 may, for example, extract a feature amount from the charging voltage curve, and estimate the degradation degree (a capacity, resistance, or a diagnosis rank or the like) from the extracted feature amount. Also, the feature amount may be extracted from a differential curve for which the charging voltage curve is differentiated. For example, as the feature amount, a maximum value, a minimum value, a peak value, or the like may be acquired. For a diagnosis method, an arbitrary method may be used.

A result display 118 displays a diagnostic result of the diagnoser 117.

FIG. 5(A) illustrates an example 1 of the charging voltage curve acquired on the basis of the charging schedule in FIG. 5(B). The horizontal axis is the time and the vertical axis is the voltage. The section “A” is the unimportant section, and the section “B” is the important section. While the charging voltage curve for which the horizontal axis is the time and the vertical axis is the voltage is illustrated here, the charging voltage curve for which the horizontal axis is the charge amount (Q=I×T) and the vertical axis is the voltage may be also generated. Or, the charging voltage curve in other forms may be generated.

FIG. 6(A) illustrates an example 2 of the charging voltage curve acquired on the basis of the charging schedule in FIG. 6(B). The section “A” is the unimportant section, the section “B” is the important section, and the section “C” is the section more important than “B”. While the charging voltage curve for which the horizontal axis is the time and the vertical axis is the voltage is illustrated here, the charging voltage curve for which the horizontal axis is the charge amount (Q=I×T) and the vertical axis is the voltage may be also generated. Or, the charging voltage curve in other forms may be generated.

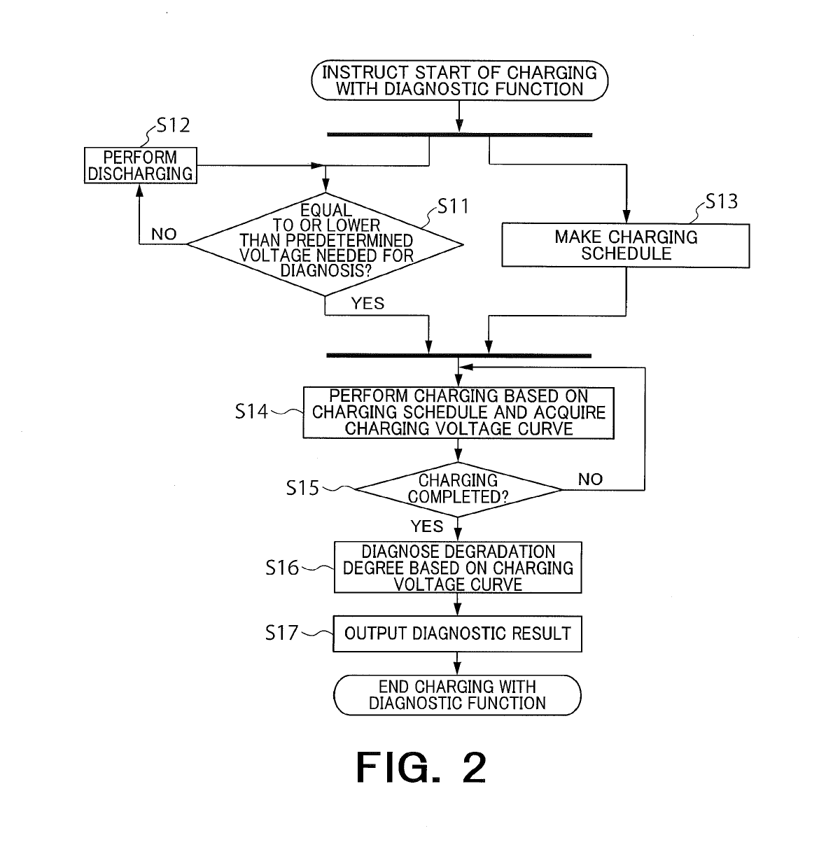

FIG. 2 is a flowchart of an operation of the charging device with the diagnostic function in FIG. 1.

The charging device with the diagnostic function is connected to the storage battery 101 and utilized. When the storage battery 101 is connected and start is commanded, diagnostic processing is started. First, the charging state of the connected storage battery 101 is checked using the voltage measurer 115, and whether or not it is equal to or lower than the predetermined voltage needed for the diagnosis is determined (S11). For example, in the case that 2.2 [V] is defined as the predetermined voltage, whether or not it is equal to or lower than 2.2 [V] is determined. Then, nothing is done when it is equal to or lower than the predetermined voltage, however, when it is greater than the predetermined voltage, the battery controller 116 performs discharging so that it becomes equal to or lower than the predetermined voltage. For example, nothing is done when it is equal to or lower than 2.2 [V], however, when it is greater than 2.2 [V], the discharging is performed so that it becomes equal to or lower than 2.2 [V] (S12).

Also, in parallel with or sequentially to discharging processing (S11, S12) based on the predetermined voltage, the charging scheduler 112 makes the charging schedule (S13). The charging schedule is made on the basis of the information of the charging voltage curve database 110 and the section-specific charge rate database 111. The charging schedule indicating the relation between the time and the charge rate is made so that the charge rate is lowered during the voltage of the important section and the charge rate is raised during the voltage of the unimportant section. Thus, that is, it is scheduled to tentatively perform increase and perform the charging so as to shorten the charging time anyway without minding the sampling of the charging voltage curve in the unimportant section, and to perform decrease so that the sampling of the charging voltage curve becomes sufficient and perform the charging in the important section. It can be said that the charge rate in the section of the voltage which is the important section is lower than the charge rate in the section of the voltage which is the unimportant section.

When both of the discharging processing (S11, S12) based on the predetermined voltage and charging schedule making (S13) are ended, next, the charging schedule executor 114 performs the charging by battery control using the battery controller 116 on the basis of the charging schedule made by the charging schedule making and measures the voltage at the time by the voltage measurer 115 until the charging is completed (514, S15). During the charging, on the basis of the time counted by the timer 113 and the charging schedule (see FIG. 5(B) and FIG. 6(B)), the charge rate is switched. That is, when the charge rate switching time comes, it is assumed that a predetermined condition is established, and the charge rate is changed.

When the charging is completed, next, the diagnoser 117 diagnoses the degradation degree of the storage battery 101 on the basis of the acquired charging voltage curve (S16). Next, the diagnostic result is displayed at the result display 118 (S17).

As described above, according to the present embodiment, by densely performing the sampling by the normal charging in the section important for diagnosing the degradation degree and sparsely performing the sampling by the rapid charging in the section not important for diagnosing the degradation degree conversely, the degradation degree of the storage battery can be accurately diagnosed, and the charging time can be shortened.

### Second Embodiment

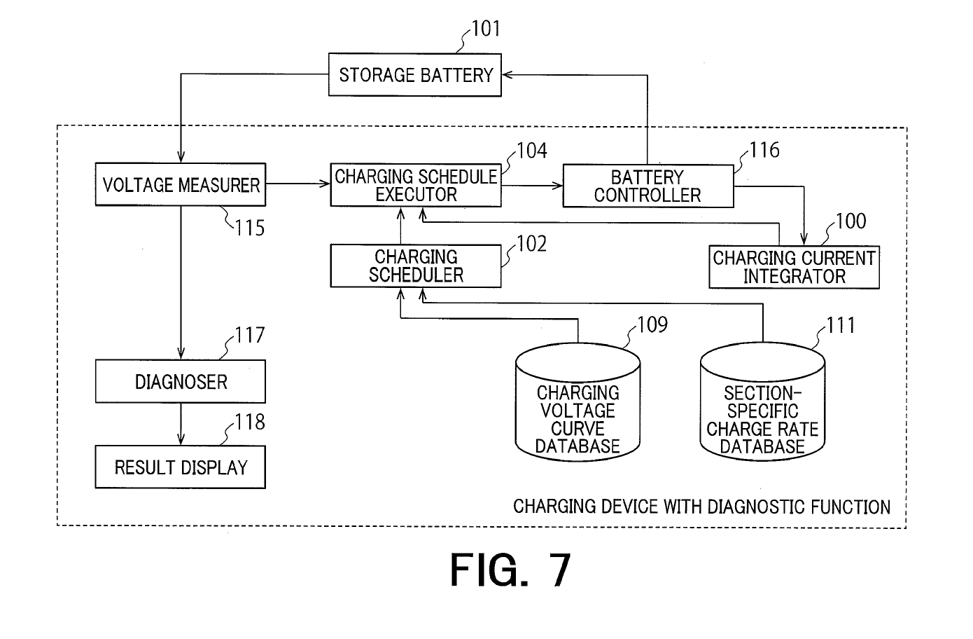

FIG. 7 is a block diagram of a charging device with a diagnostic function relating to a second embodiment of the present invention.

A point different from the first embodiment is that the timer 113 in the first embodiment does not exist, and a charging current integrator 100 is added. While the charging schedule that determines the current rate according to the time (the charging schedule of time control) is made in the first embodiment, a charging schedule that determines the current rate according to an integrated charge amount (the charging schedule of integrated current amount control) is made in the present embodiment. Hereinafter, only differences from the first embodiment will be described, and excluding extended or changed processing, redundant description will be omitted.

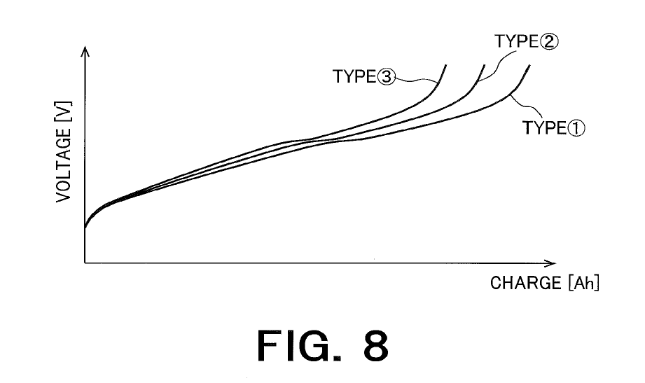

FIG. 8 is an example of a charging voltage curve database 109 relating to the second embodiment.

The charging voltage curves of three types of the batteries are stored. The horizontal axis is the charge amount [Ah], and the vertical axis is the voltage [V]. It is a different point that the horizontal axis is the time in the first embodiment but it is the charge amount in the present embodiment.

The charging current integrator 100 acquires information of a charging current amount from the battery controller 116, integrates the charging current amount, and delivers information of an integrated charging current amount to a charging schedule executor 104.

A charging scheduler 102 makes the charging schedule on the basis of the information of the charging voltage curve database 109 and the information of the section-specific charge rate database 111. The charging schedule made here determines the charge rate to be used according to a value of the integrated charging current amount from the charging start.

The charging scheduler 102 checks the charging state of the connected storage battery 101, defines the charging state as the start point when it is equal to or lower than the predetermined voltage, and when it is higher than the predetermined voltage, performs the discharging processing until it becomes equal to or lower than the predetermined voltage, and defines the charging state after the discharging processing is performed as the start point. From information on a change of the voltage according to the charge rate and the charge amount illustrated in FIG. 8, the charge amount before getting out of the section to which the start point belongs first is calculated. For example, when the start point is 2.0 [V], the charge amount before reaching the end voltage 2.2 [V] of the first important section “B” (reaching the first unimportant section “A”) is calculated. Next, with the start voltage of the unimportant section “A” that is reached first as a start point, from the information on the change of the voltage according to the charge rate and the charge amount illustrated in FIG. 8, the charge amount before getting out of the section “A” (the time before reaching 2.3 [V] which is the end voltage of the section “A”) is calculated. By repeating such calculation, the charging schedule that determines the charge rate according to an integrated value of the charge amount is made. The schedule that determines the charge rate according to a current amount integrated value is made. The end of the charging may be the completion of the charging (until no more current flows), or the arbitrarily voltage equal to or higher than 2.5 [V] may be specified by a user to make a schedule.

### Third Embodiment

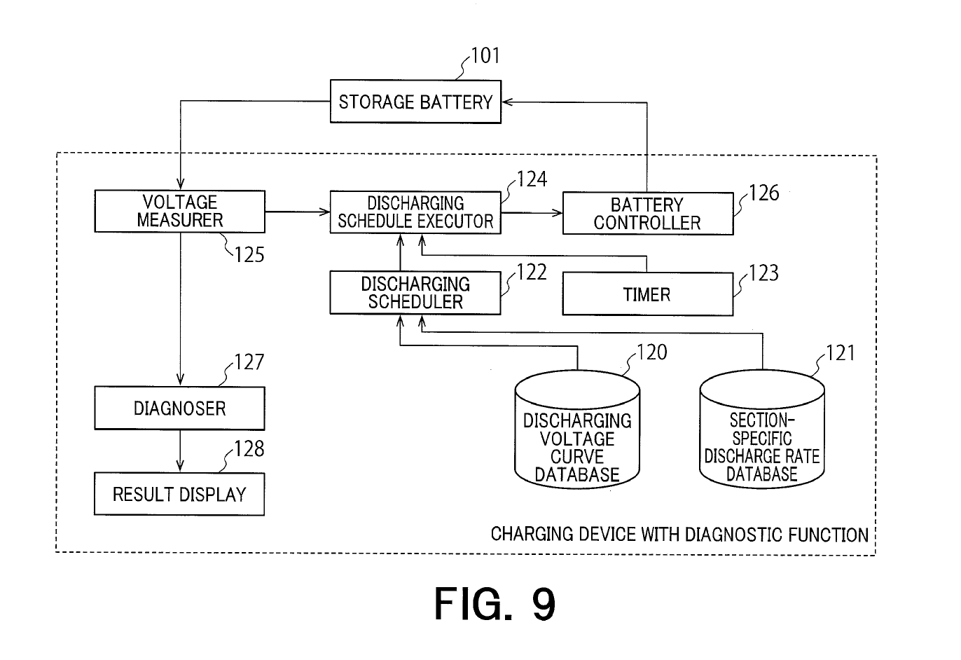

FIG. 9 is a block diagram of a discharging device (discharging computer) with a diagnostic function relating to a third embodiment of the present invention.

The discharging device with the diagnostic function is characterized in that, in the case of sampling the voltage and acquiring a discharging voltage curve while discharging the storage battery from a voltage value equal to or higher than the predetermined voltage, and diagnosing the storage battery based on the acquired discharging voltage curve, a discharge rate is controlled according to a section of a discharging voltage during discharging. Sampling is performed densely by normal discharging in the section important for diagnosing the degradation degree, and sampling is performed sparsely by performing rapid discharging in the section not important for diagnosing the degradation degree conversely. It is assumed that a sampling rate is constant during the discharging. Thus, the degradation degree of the storage battery can be accurately diagnosed, and discharging time can be shortened.

While the charge rate is controlled according to the time and the voltage is measured during a time period when performing the charging in the first embodiment, it is a different point that the discharge rate is controlled according to the time and the voltage is measured during a time period when performing not the charging but the discharging in the present embodiment. Other than that, it is basically similar to the first embodiment. The description redundant with the first embodiment will be omitted.

A battery controller 126 controls charging and discharging of the storage battery 101 under control of a discharging schedule executor 124.

A timer 123 has the function of counting the time.

A voltage measurer 125 measures the voltage of the storage battery 101 during a time period when a discharging schedule is executed by the discharging schedule executor 124. Also, before the discharging schedule is executed, an instruction of the discharging schedule executor 124 is received and the voltage of the storage battery 101 is measured. Here, the discharging schedule in the present embodiment determines the discharge rate according to the time from discharging start.

A discharging scheduler 122 makes the discharging schedule on the basis of information of a discharging voltage curve database (hardware storage) 120 and information of a section-specific discharge rate database (hardware storage) 121. Similarly to the first embodiment, the schedule for which the horizontal axis is the time and the vertical axis is the discharge rate is made. For a method of making the schedule, since only charging and discharging are different and it is obvious from the description of charging schedule making in the first embodiment, the description will be omitted.

The discharging schedule executor 124 discharges the storage battery 101 while controlling the battery controller 116 on the basis of the discharging schedule generated by the discharging scheduler 122, and samples the voltage during the discharging at the specified sampling rate using the voltage measurer 125. Since a diagnosis is made by starting the discharging from the voltage equal to or higher than the predetermined voltage value, the discharging schedule executor 124 checks whether or not the voltage of the storage battery 101 is equal to or higher than the predetermined voltage using the voltage measurer 125 before the start, and when it is lower than the predetermined voltage, uses the battery controller 116 to charge the storage battery 101.

A diagnoser 127 acquires a voltage value measured by the voltage measurer 125 during a time period when the discharging schedule is executed, and generates the discharging voltage curve which is one example of the information indicating the relation between the voltage and the time. Or, the voltage value measured by the voltage measurer 125 while the discharging schedule is executed and the information of the discharge rate are acquired, and the discharging voltage curve which is one example of information indicating a relation between the voltage and a discharge amount is generated. The degradation degree of the storage battery 101 is diagnosed on the basis of the discharging voltage curve. For a diagnosis method using the discharging voltage curve, an arbitrary method may be used.

A result display 128 displays a diagnostic result of the diagnoser 127.

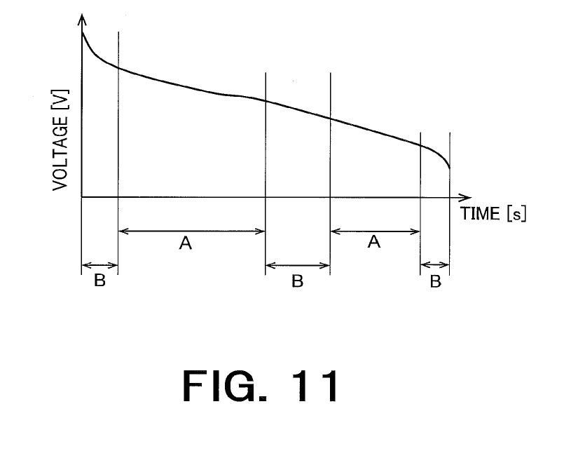

FIG. 11 illustrates an example of the discharging voltage curve acquired on the basis of the discharging schedule. The horizontal axis is the time, and the vertical axis is the voltage. It is the example in which the section “A” is the unimportant section and the section “B” is the important section.

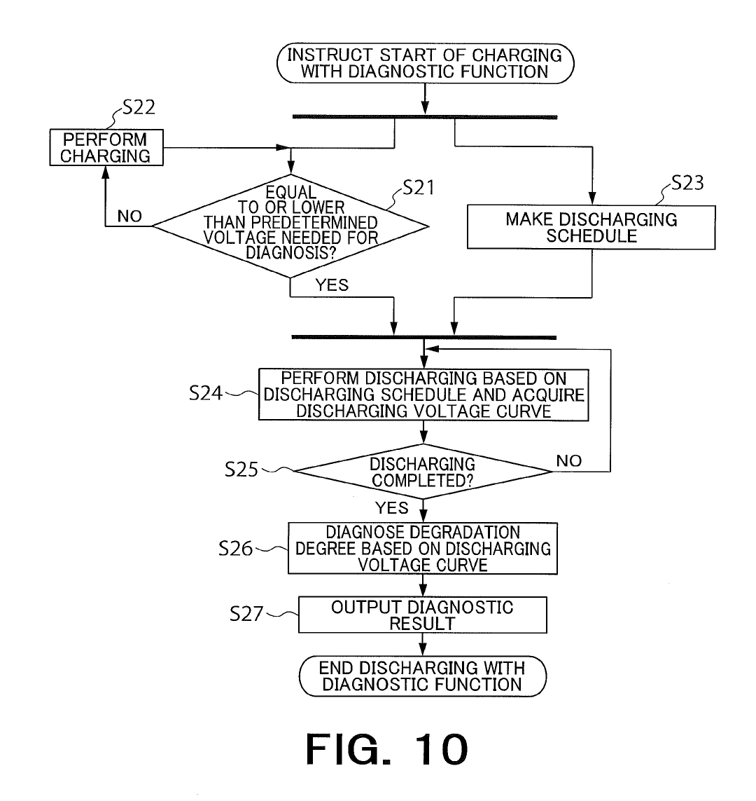

FIG. 10 is a flowchart of an operation of the discharging device with the diagnostic function in FIG. 9.

The discharging device with the diagnostic function is connected to the storage battery 101 and utilized. When the storage battery 101 is connected and the start is commanded, the diagnostic processing is started. First, the charging state of the connected storage battery 101 is checked using the voltage measurer 125, and whether or not it is equal to or higher than the predetermined voltage needed for the diagnosis is determined (S21). For example, in the case that 2.2 [V] is defined as the predetermined voltage, whether or not it is equal to or higher than 2.2 [V] is determined. Then, nothing is done when it is equal to or higher than the predetermined voltage, however, when it is lower than the predetermined voltage, the battery controller 116 performs the charging so that it becomes equal to or higher than the predetermined voltage. For example, nothing is done when it is equal to or higher than 2.2 [V], however, when it is lower than 2.2 [V], the charging is performed so that it becomes equal to or higher than 2.2 [V] (S22).

Also, in parallel with or sequentially to charging processing (S21, S22) based on the predetermined voltage, the discharging scheduler 122 makes the discharging schedule (S23). The discharging schedule is made on the basis of the information of the discharging voltage curve database 120 and the section-specific discharge rate database 121. The discharging schedule indicating the relation between the time and the discharge rate which lowers the discharge rate during the voltage of the important section and raises the discharge rate during the voltage of the unimportant section is made. That is, it is scheduled to tentatively perform increase and perform the discharging so as to shorten the discharging time anyway without minding the sampling of the discharging voltage curve in the unimportant section, and to perform decrease so that the sampling of the discharging voltage curve becomes sufficient and perform the discharging in the important section. It can be said that the discharge rate in the section of the voltage which is the important section is lower than the discharge rate in the section of the voltage which is the unimportant section.

When both of the charging processing (S21, S22) based on the predetermined voltage and discharging schedule making (S23) are ended, next, the discharging schedule executor 124 performs the discharging by the battery control using the battery controller 126 on the basis of the discharging schedule made by the discharging schedule making and acquires the voltage at the time by the voltage measurer 125 until the discharging is completed (S24, S25). During the discharging, on the basis of the time counted by the timer 123 and the discharging schedule, the discharge rate is switched. That is, when the discharge rate switching time comes, it is assumed that the predetermined condition is established, and the discharge rate is changed.

When the discharging is completed, next, the diagnoser 127 diagnoses the degradation degree of the storage battery 101 on the basis of the discharging voltage curve based on the acquired voltage (S26). Next, the diagnostic result is displayed at the result display 128 (S27).

As described above, according to the present embodiment, by densely performing the sampling by the normal discharging in the section important for diagnosing the degradation degree and sparsely performing the sampling by the rapid discharging in the section not important for diagnosing the degradation degree conversely, the degradation degree of the storage battery can be accurately diagnosed, and the discharging time can be shortened.

Note that, in fourth to eighth embodiments described below, a charging device with a diagnostic function will be described, however, by replacing an operation related to the charging with an operation related to the discharging in the following description, it can be achieved as a discharging device with a diagnostic function as well, similarly to the present embodiment. Also, the already described second embodiment can be achieved also as a discharging device with a diagnostic function by replacing the operation related to the charging with the operation related to the discharging.

### Fourth Embodiment

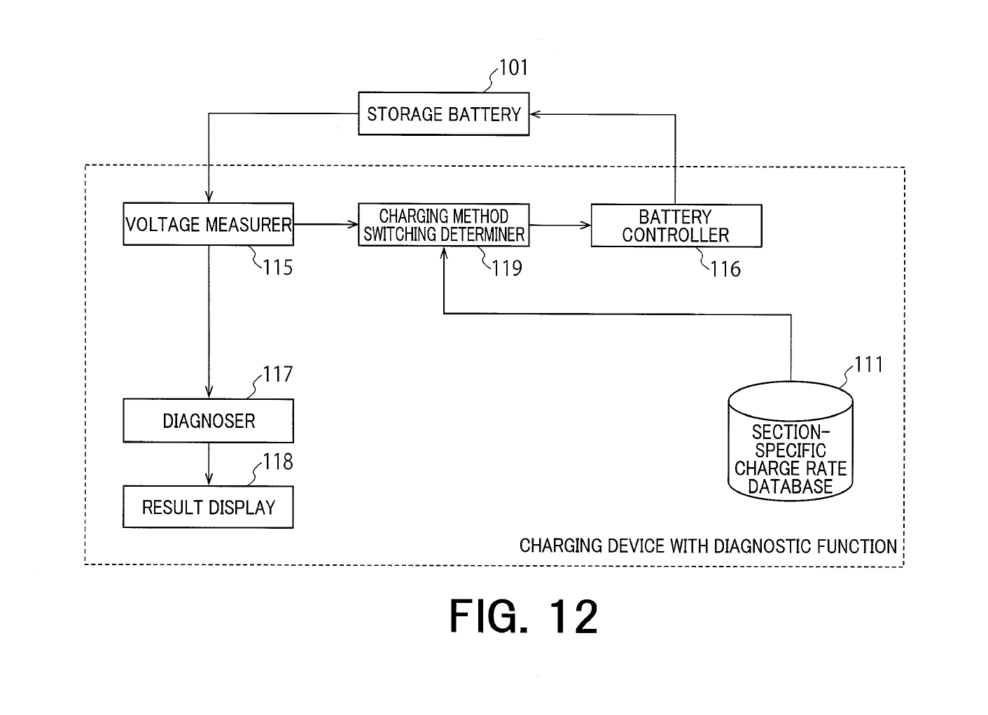

FIG. 12 is a block diagram of a charging device with a diagnostic function relating to a fourth embodiment of the present invention.

The same signs are attached to elements of the same names as in FIG. 1, and except for extended or changed processing, the redundant description will be omitted.

In a configuration of the first embodiment illustrated in FIG. 1, it is needed to make the charging schedule beforehand before starting actual diagnostic processing. On the other hand, in a configuration illustrated in FIG. 12, it is not needed to make the charging schedule beforehand.

A charging method switching determiner 119 monitors the charging state of the storage battery 101 using the voltage measurer 115, and when the charging state becomes equal to or lower than the predetermined voltage, immediately starts the charging. The charging method switching determiner 119 monitors the voltage during the charging through the charging voltage measurer 115, and switches the charging method (charge rate) in real time according to the voltage that is being monitored and the information of the section-specific charge rate database 111.

That is, while the charge rate is switched according to the time based on the charging schedule formed beforehand in the first embodiment, the charge rate is switched according to the voltage that is being monitored in the present embodiment. For example, in the example of the type 1 of the section-specific charge rate database 111 illustrated in FIG. 4, the charging method switching determiner 119 performs the charging at the charge rate corresponding to the voltage section “A” when the voltage becomes equal to or higher than 2.2 [V], and switches to the charge rate corresponding to the voltage section “B” when the voltage becomes equal to or higher than 2.3 [V]. In this way, when the voltage that is being monitored reaches an end voltage or a start voltage of the section, it is assumed that the predetermined condition is established, and the charge rate is changed.

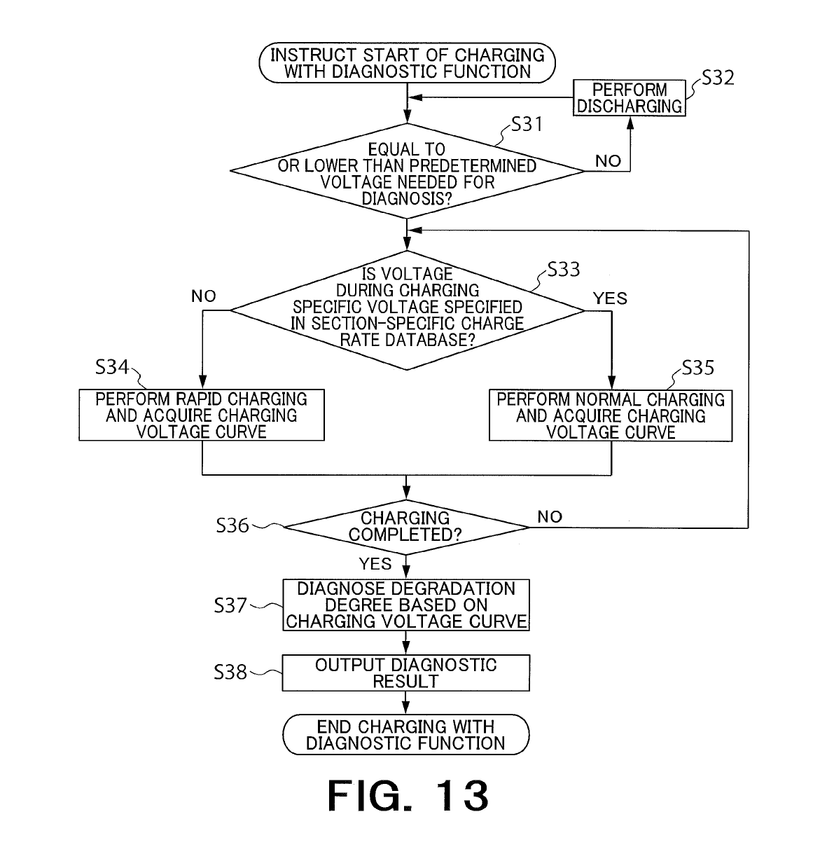

FIG. 13 is a flowchart of an operation of the charging device with the diagnostic function in FIG. 12.

The charging method switching determiner 119 performs the discharging using the battery controller 116 until the voltage becomes equal to or lower than the predetermined voltage needed for the diagnosis (S31, S32), and starts the charging when it becomes equal to or lower than the predetermined voltage (S33). The voltage during the charging is monitored, dense sampling is performed by performing the normal charging when the voltage during the charging is within the important voltage section, and sparse sampling is performed by performing the rapid charging when it is in the unimportant voltage section (S34, S35). Note that the charge rate of the rapid charging is higher than the charge rate of the normal charging. While the example of changing the charge rate in two stages is illustrated here, it may be three or more stages. When the charging is completed (S36), the diagnoser 117 diagnoses the degradation degree on the basis of the charging voltage curve including the sparsely and densely sampled voltage values (S37), and the result display 118 displays the diagnostic result (S38).

Note that, as a modification of the fourth embodiment, a configuration of calculating a differential coefficient of a charging/discharging curve during the charging and changing the charge rate according to the differential coefficient (depending on whether it is equal to or larger than a specified threshold or smaller for example) is also possible. In this case, for example, it is defined as the important section for the voltage for which the differential coefficient is equal to or larger than the specified threshold, and it is defined as the unimportant section for a range of the voltage smaller than the specified threshold.

As described above, according to the present embodiment, in addition to effects of the first embodiment, a new effect that it is not needed to make the charging schedule beforehand can be obtained.

### Fifth Embodiment

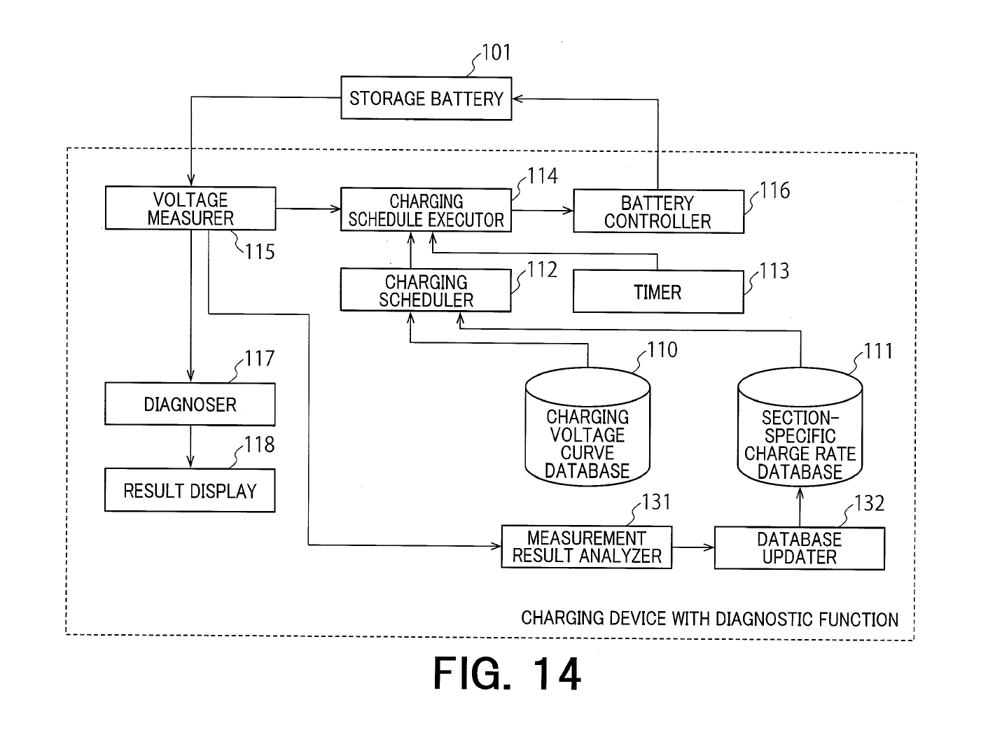

FIG. 14 is a block diagram of a charging device with a diagnostic function relating to a fifth embodiment of the present invention.

The same signs are attached to the elements of the same names in FIG. 1, and except for the extended or changed processing, the redundant description will be omitted.

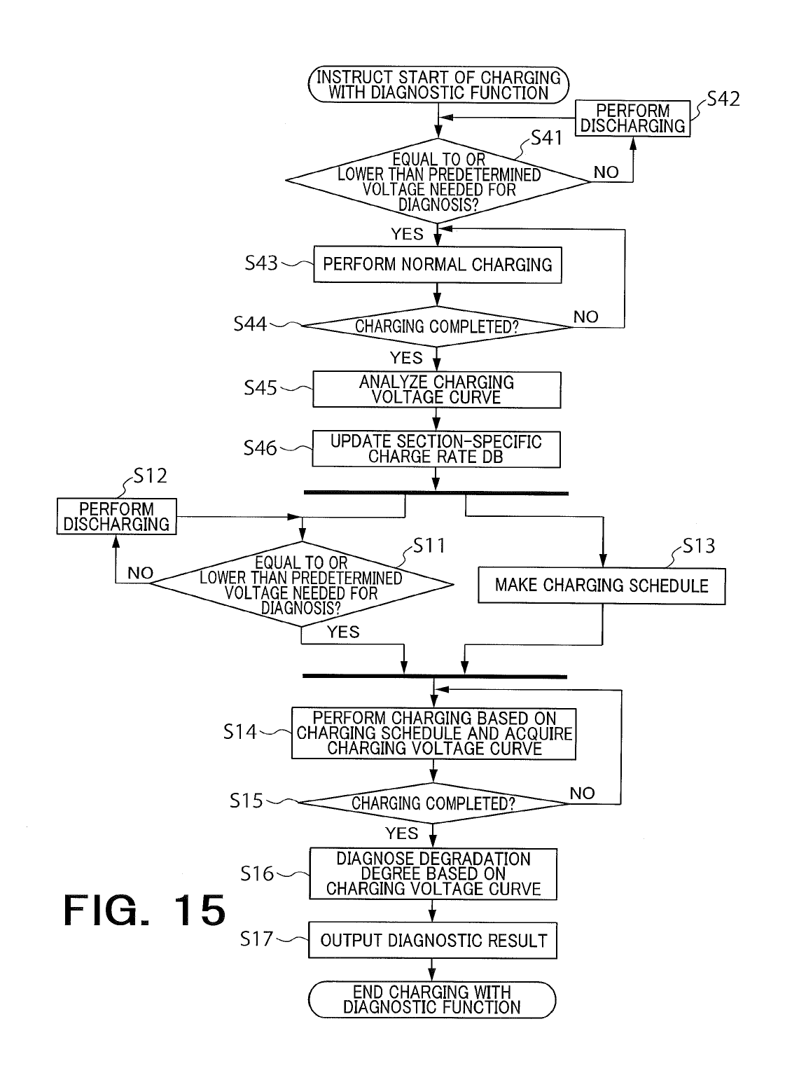

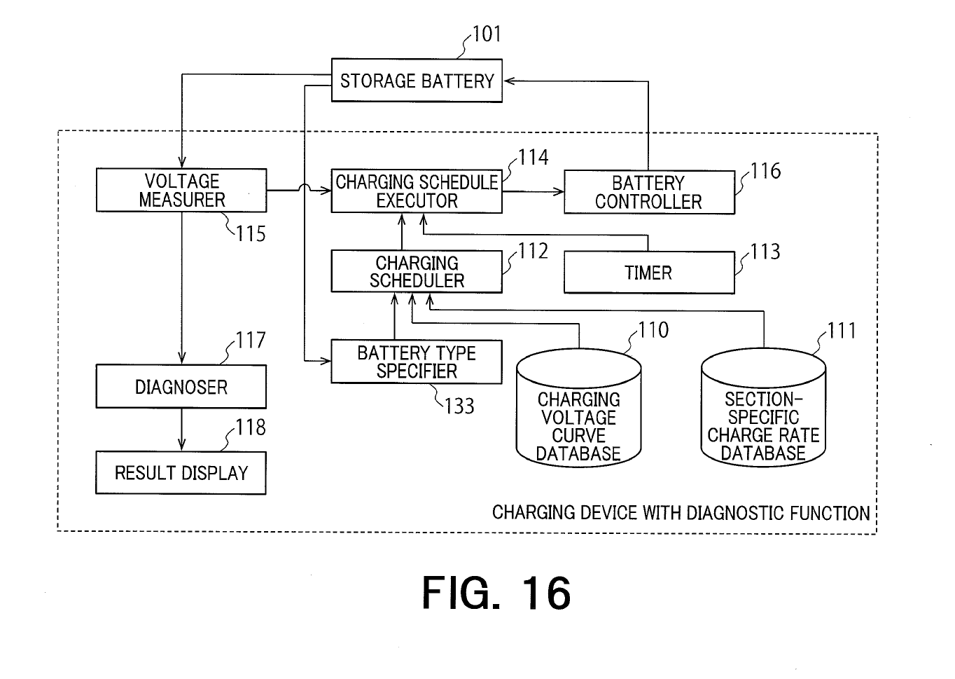

In the charging device with the diagnostic function in the present embodiment, a measurement result analyzer 131 and a database updater 132 are added to the charging device with the diagnostic function in the first embodiment. Hereinafter, using a flowchart in FIG. 15, operations of the measurement result analyzer 131 and the database updater 132 will be described.

FIG. 15 is a flowchart of an operation of the charging device with the diagnostic function in FIG. 14.

The charging device with the diagnostic function is connected to the storage battery and utilized. When the storage battery is connected and processing start is commanded, the diagnostic processing is started. First, the charging schedule executor 114 checks the charging state of the connected storage battery 101 using the voltage measurer 115, and determines whether or not it is equal to or lower than the predetermined voltage needed for the diagnosis (S41). Then, nothing is done when it is equal to or lower than the predetermined voltage, however, when it is greater than the predetermined voltage, the discharging is performed so that it becomes equal to or lower than the predetermined voltage (S42).

Next, the charging schedule executor 114 performs the charging at the predetermined charge rate, the normal charging for example, using the battery controller 116 until the charging is completed (S43, S44). Then, the measurement result analyzer 131 analyzes the charging voltage curve which is one example of charging voltage data based on the voltage value obtained from the voltage measurer 115 in the middle of the normal charging (S45).

Here, for analysis, for example, the differential coefficient is calculated for the charging voltage curve (the charging voltage curve of the voltage and the charge amount, or the charging voltage curve of the voltage and the time or the like), it is defined as the important section for the voltage for which the differential coefficient is equal to or larger than the specified threshold, and it is defined as the unimportant section for a range of the voltage smaller than the specified threshold. In addition, it is also conceivable to define the section of the voltage corresponding to the charge amount for which the charge amount is in a range specified beforehand as the important section and to define the other section as the unimportant section. The relation between the differential coefficient and the voltage and the relation between the charge amount and the voltage correspond to one example of the relation between the voltage measured during the charging at the predetermined charge rate and the charge amount of the storage battery 101 at the time. Note that the charge amount can be calculated from elapsed time from the charging start and the applied charge rate.

In this way, a specific analysis method may be appropriately configured in a range not deviating from the subject matter of the present invention. Then, on the basis of a result of the analysis in step S45, the database updater 132 updates the section-specific charge rate database 111. That is, the section-specific charge rate information of the pertinent type is updated.

Here, for updating, for example, a method of setting an arbitrary coefficient as in the following equation and appropriately correcting the important section is conceivable.

Vnew=Vold×α+Vnow×β

Here, “Vnew” denotes the voltage after correction indicating the important section of the charging voltage curve, “Vold” denotes the voltage before the correction indicating the important section of the charging voltage curve, “Vnow” denotes the voltage which is the result of the analysis of this time indicating the important section of the charging voltage curve, and “α” and “β” denote arbitrary coefficients.

It is a correction method of taking an average when setting is performed like α=13=0.5, it is a correction method of gradually forgetting “Vold” when setting is performed like α=0.9 and β=0.1, and it is a correction method of performing overwrite with “Vnow” at all times when setting is performed like α=0 and β=1.

Also, for example, a method of newly adding a voltage indicating a charging voltage curve important section of the pertinent battery type when it is determined that the battery type not stored in the section-specific charge rate database 111 is connected as the result of the analysis is also conceivable.

In this way, a specific updating method may be appropriately configured in the range not deviating from the subject matter of the present invention.

In the case that a desired result cannot be obtained as the result of the analysis, the charging method may be changed, the charging voltage curve may be acquired again, and the analysis may be performed again. After the section-specific charge rate database 111 is updated, the processing is equal to that described in FIG. 2 (S11-S17).

As described above, according to the present embodiment, in addition to the effects of the first embodiment, a new effect that trade-off of estimation accuracy of the degradation degree of the storage battery and the charging time can be improved more can be obtained.

### Sixth Embodiment

FIG. 16 is a block diagram of a charging device with a diagnostic function relating to a sixth embodiment of the present invention.

To the charging device with the diagnostic function relating to the first embodiment illustrated in FIG. 1, a battery type specifier 133 is added. The battery type specifier 133 specifies the type of the storage battery 101 connected to the charging device with the diagnostic function. The charging scheduler 112 acquires the information corresponding to the type of the storage battery 101 specified by the battery type specifier 133 from the section-specific charge rate database 111. For example, it is assumed that the battery type specifier 133 specifies the type 1 as the type of the storage battery 101, and the section-specific charge rate database 111 is FIG. 4. In this case, the charging scheduler 112 acquires the information of the type 1 from the section-specific charge rate database 111 in FIG. 4.

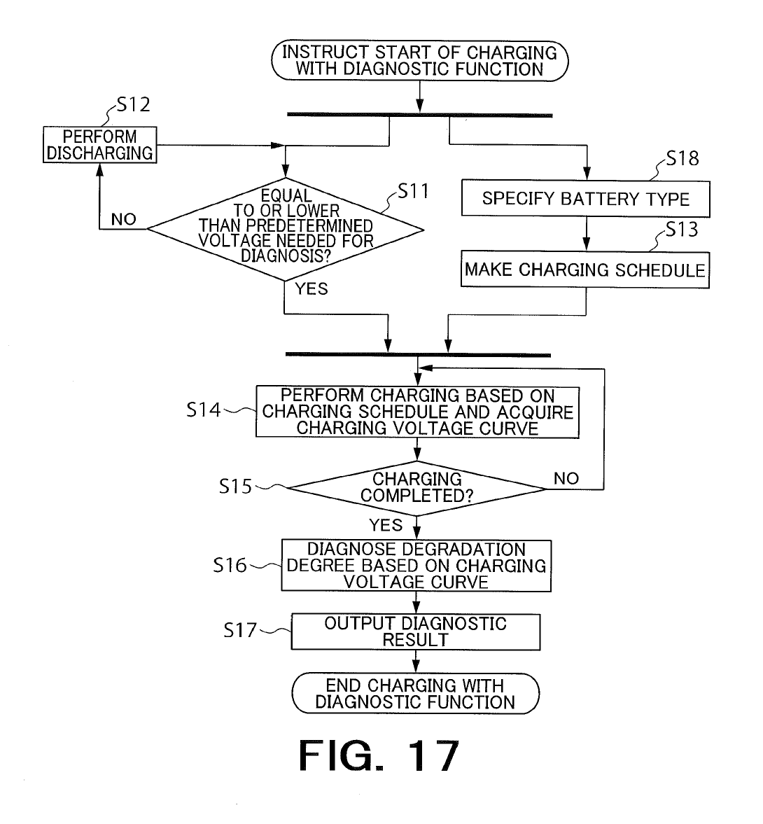

FIG. 17 is a flowchart of an operation of the charging device with the diagnostic function in FIG. 16. To the operation in the first embodiment illustrated in FIG. 2, processing of specifying the battery type is added (S18) before the charging schedule making (S13). In the charging schedule making (S13), the charging scheduler 112 acquires the information according to the specified battery type from the section-specific charge rate database 111.

Other than this, since it is similar to the first embodiment, the description will be omitted.

As described above, according to the present embodiment, in addition to the effects of the first embodiment, a new effect that the diagnostic processing can be appropriately performed even in the case that the type of the connected storage battery is changed can be obtained.

### Seventh Embodiment

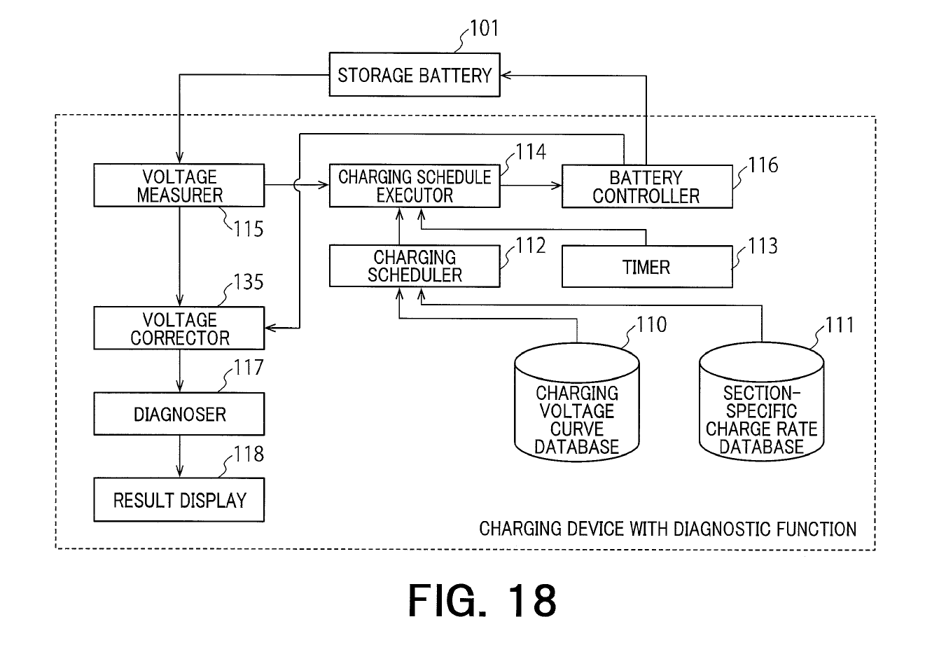

FIG. 18 is a block diagram of a charging device with a diagnostic function relating to a seventh embodiment of the present invention.

To the charging device with the diagnostic function relating to the first embodiment illustrated in FIG. 1, a voltage corrector 135 is added.

The present embodiment is characterized in that a voltage drop generated by the change of the charge rate in the middle is taken into consideration and the charging voltage curve acquired by execution of the charging schedule is corrected as if the voltage is not dropping. Thus, an evaluation can be made assuming that the rate at the start of the charging continues to the completion of the charging for example.

For this, the voltage corrector 135 holds a correlation between the charge rate and the voltage drop as information beforehand, and acquires the information of the charge rate during the charging from the battery controller 116.

The battery controller 116 notifies the charge rate to be used first at the start of the charging for example to the voltage corrector 135, and thereafter, every time the charge rate is changed, notifies the charge rate after the change to the voltage corrector 135. The voltage corrector 135 manages the value of the voltage acquired from the voltage measurer 115 in correspondence with the charge rate notified from the battery controller 116. The voltage corrector 135 corrects the voltage drop on the basis of these pieces of the information.

Here, for the correction, for example, it is conceivable to change a correction coefficient according to the charge rate as in the following equation and perform the correction by the correction coefficient.

Vnew=Vold+γ(i)

γ(i)=δ×i

Here, “Vnew” denotes the voltage after the correction, “Vold” denotes the voltage before the correction, “γ(i)” denotes the correction coefficient according to the charge rate, “δ” denotes a coefficient, and “i” denotes the charge rate.

By changing the correction coefficient “γ(i)” according to the charge rate and adding or multiplying the correction coefficient “γ(i)” or the like, the charging voltage curve is corrected.

Also, it is conceivable to change the correction coefficient according to a temperature as in the following equation.

γ(i)=δ(T)×i

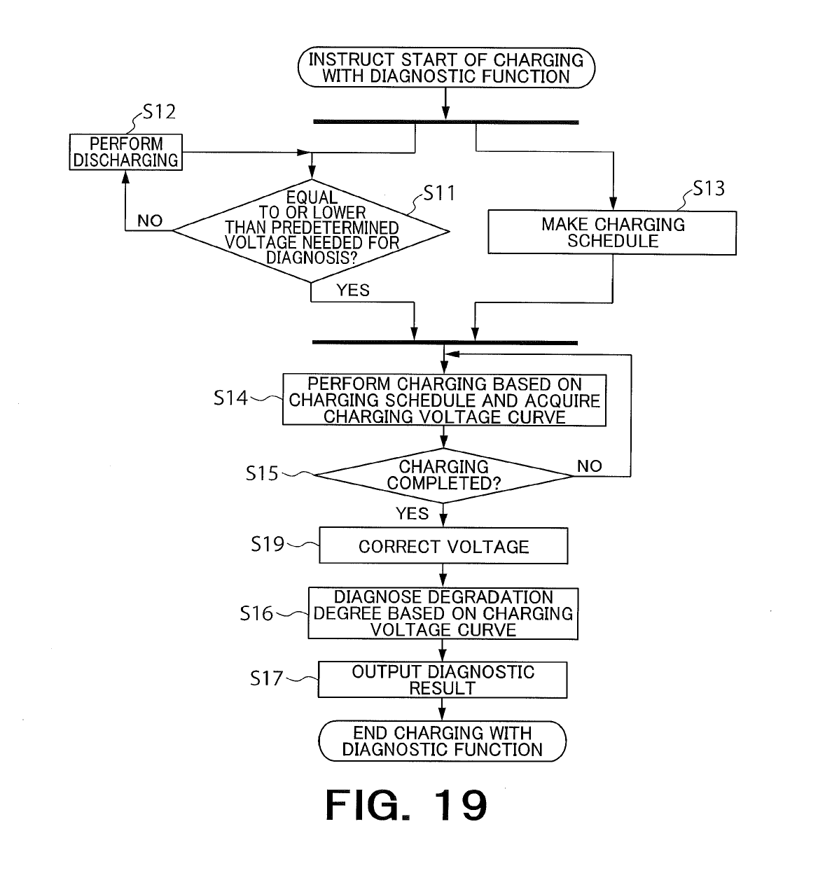

Here, “δ(T)” denotes a coefficient that changes according to the temperature. The coefficient “δ(T)” is changed according to the temperature, and the charging voltage curve is corrected. FIG. 19 is a flowchart of an operation of the charging device with the diagnostic function in FIG. 18. Processing (S19) in which the voltage corrector 135 corrects the charging voltage curve after the charging is completed is added. Other than this, since it is similar to the first embodiment illustrated in FIG. 2, the description will be omitted.

As described above, according to the present embodiment, in addition to the effects of the first embodiment, a new effect that a diagnosis can be made neglecting the voltage drop due to the change of the charge rate can be obtained further.

### Eighth Embodiment

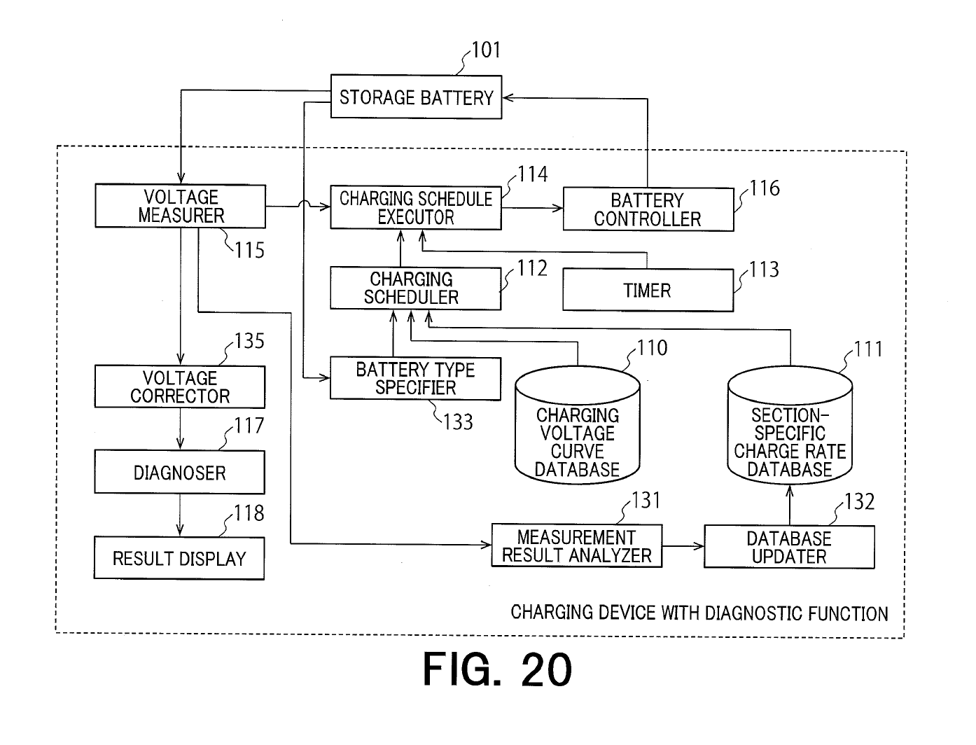

FIG. 20 is a block diagram of a charging device with a diagnostic function relating to an eighth embodiment of the present invention.

The charging device with the diagnostic function illustrated in FIG. 20 performs the operation for which the first, fifth, sixth and seventh embodiments are combined.

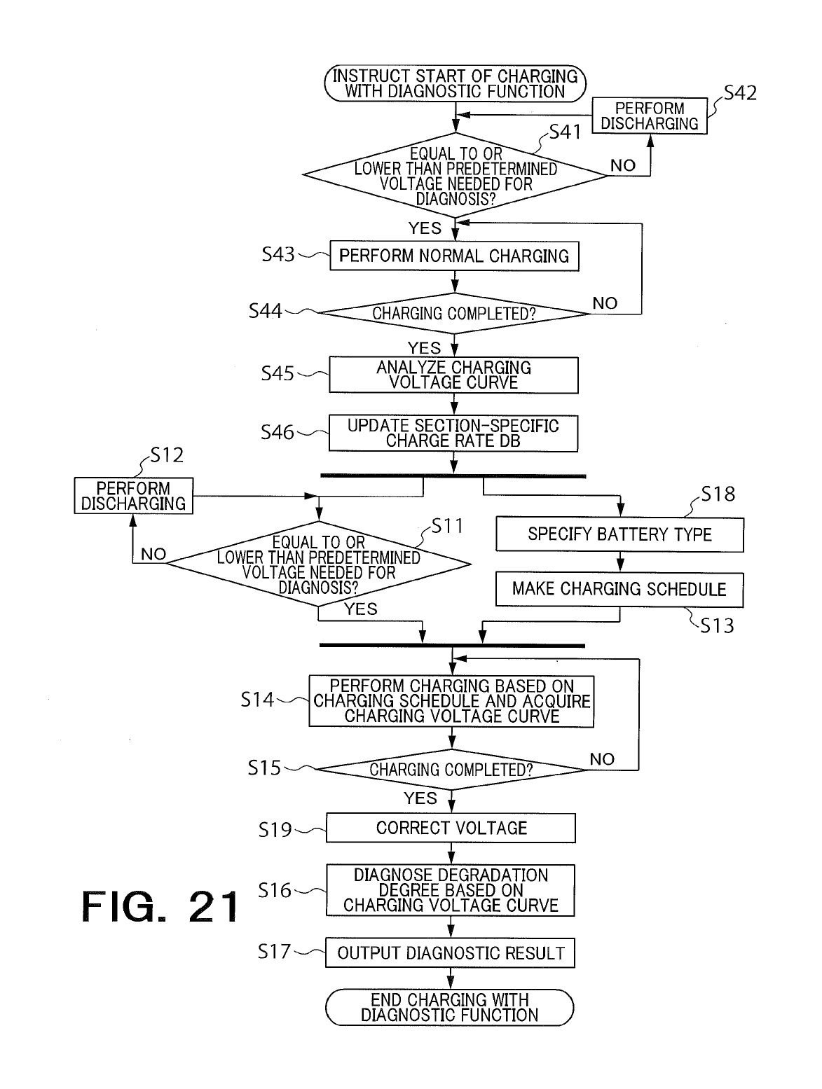

FIG. 21 is a flowchart of the operation of the charging device with the diagnostic function in FIG. 20. It is the one for which the flowcharts described in the first, fifth, sixth and seventh embodiments are integrated. Since contents of the processing is obvious, the description will be omitted.

As described above, according to the present embodiment, in addition to the effects of the first embodiment, the effects of the first, fifth, sixth and seventh embodiments can be obtained in a combined manner.

The present invention is not limited to the above described embodiments as they are, and constituent elements can be substantiated with deformation within a range not deviating from the gist thereof in a practical phase. Various inventions can be formed by appropriate combinations of the plurality of constituent elements disclosed in the above described embodiments. For example, some constituent elements can be deleted from all the constituent elements shown in the embodiments, and the elements across the different embodiments can be appropriately combined.

1. A charging device comprising:
a battery controller to control charging of a storage battery;
an executor to charge the storage battery using the battery controller and change a charge rate of the storage battery in a case that a predetermined condition is established during a time period when the storage battery is charged;
a voltage measurer to measure a voltage of the storage battery during a time period when the storage battery is charged by the battery controller;
a voltage corrector to correct the voltage measured by the voltage measurer on a basis of a value of a current rate at which the voltage is measured; and
a diagnoser to diagnose the storage battery on a basis of the voltage corrected by the voltage corrector.

2. The charging device according to claim 1, comprising
a timer to count a time,
wherein the executor controls the charge rate of the storage battery according to elapsed time from charging start.

3. The charging device according to claim 1, comprising
a charging current integrator to calculate an integrated value of a charge amount of the storage battery during the charging,
wherein the executor controls the charge rate according to the integrated value of the charge amount of the storage battery during the charging.

4. The charging device according to claim 1,
wherein the executor monitors the voltage of the storage battery during a time period when the storage battery is charged by the battery controller, and
wherein the executor controls the charge rate according to the voltage of the storage battery during the charging.

5. The charging device according to claim 1,
wherein the executor controls the charge rate according to a differential coefficient of charging voltage data based on the voltage acquired during the charging.

6. The charging device according to claim 1,
wherein the voltage measurer measures the voltage of the storage battery at a specified sampling rate.

7. A charging device comprising,
a battery controller to control charging of a storage battery;
an executor to charge the storage battery using the battery controller and change a charge rate of the storage battery in a case that a predetermined condition is established during a time period when the storage battery is charged;
a voltage measurer to measure a voltage of the storage battery during a time period when the storage battery is charged by the battery controller;
a diagnoser to diagnose the storage battery on a basis of the voltage measured by the voltage measurer; and
a measurement result analyzer
wherein the executor charges the storage battery at a predetermined charge rate using the battery controller,
the measurement result analyzer acquires a relation between the voltage measured by the voltage measurer during the charging at the predetermined charge rate and a charge amount of the storage battery during a time period when the voltage is measured, and generates charge rate information which determines a relation between the voltage and the charge rate on a basis of the relation between the voltage and the charge amount, and
the executor monitors the voltage of the storage battery during a time period when the storage battery is charged by the battery controller, and controls the charge rate according to the voltage of the storage battery during the charging, using the charge rate information.

8. A charging method comprising:
executing charging of a storage battery using a battery controller that controls the charging of the storage battery, and changing of a charge rate of the storage battery in a case that a predetermined condition is established during a time period when the storage battery is charged;
measuring a voltage of the storage battery during a time period when the storage battery is charged;
correcting the measured voltage on a basis of a value of a current rate at which the voltage is measured; and
diagnosing the storage battery on a basis of the corrected voltage.

9. A discharging device comprising:
a battery controller to control discharging of a storage battery;
an executor to discharge the storage battery using the battery controller and change a discharge rate of the storage battery in a case that a predetermined condition is established during a time period when the storage battery is discharged;
a voltage measurer to measure a voltage of the storage battery during a time period when the storage battery is discharged by the battery controller;
a voltage corrector to correct the voltage measured by the voltage measurer on a basis of a value of the current rate at which the voltage is measured; and
a diagnoser to diagnose the storage battery on a basis of the voltage corrected by the voltage corrector.

10. The discharging device according to claim 9, comprising
a timer to count a time,
wherein the executor controls the discharge rate of the storage battery according to elapsed time from discharging start.

11. The discharging device according to claim 10, comprising
a discharging current integrator to calculate an integrated value of a discharge amount of the storage battery during the discharging,
wherein the executor controls the discharge rate according to the integrated value of the discharge amount of the storage battery during the discharging.

12. The discharging device according to claim 10,
wherein the executor monitors the voltage of the storage battery during a time period when the storage battery is discharged by the battery controller, and
wherein the executor controls the discharge rate according to the voltage of the storage battery during the discharging.

13. The discharging device according to claim 10,
wherein the executor controls the discharge rate according to a differential coefficient of discharging voltage data based on the voltage acquired during the discharging.

14. The discharging device according to claim 10,
wherein the voltage measurer measures the voltage of the storage battery at a specified sampling rate.

15. The discharging device according to claim 13,
a battery controller to control discharging of a storage battery;
an executor to discharge the storage battery using the battery controller and change a discharge rate of the storage battery in a case that a predetermined condition is established during a time period when the storage battery is discharged;
a voltage measurer to measure a voltage of the storage battery during a time period when the storage battery is discharged by the battery controller;
a diagnoser to diagnose the storage battery on a basis of the voltage measured by the voltage measurer; and
a measurement result analyzer
wherein the executor discharges the storage battery at a predetermined discharge rate using the battery controller,
the measurement result analyzer acquires a relation between the voltage measured by the voltage measurer during the discharging at the predetermined discharge rate and a discharge amount of the storage battery when the voltage is measured, and generates discharge rate information which determines a relation between the voltage and the discharge rate on a basis of the relation between the voltage and the discharge amount, and
the executor monitors the voltage of the storage battery during a time period when the storage battery is discharged by the battery controller, and controls the discharge rate according to the voltage of the storage battery during the discharging, using the discharge rate information.

16. A discharging method comprising:
discharging a storage battery using a battery controller controlling discharging of the storage battery, and changing a discharge rate of the storage battery in a case that a predetermined condition is established during a time period when the storage battery is discharged;
measuring a voltage of the storage battery during a time period when the storage battery is discharged;
correcting the measured voltage on a basis of a value of the current rate at which the voltage is measured; and
diagnosing the storage battery on a basis of the corrected voltage.
